(19) United States
(12) Patent Application Publication
(10) Pub. No.: US 2001/0049811 A1
(43) Pub. Date: Dec. 6, 2001

(54) Pattern distortion correction device, pattern distortion correction method, and recording medium recording a pattern distortion correction program

(75) Inventor: Hironobu Taoka, Tokyo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 09/734,203

(22) Filed: Dec. 12, 2000

(30) Foreign Application Priority Data
Jun. 5, 2000 (JP) 2000-167609

(51) Int. Cl. G06F 17/50

(52) U.S. Cl. 716/4; 716/5; 716/21

(57) ABSTRACT

A pattern distortion correction device which performs distortion correction of a layout pattern is provided, considering not only an edge shift value but also a process margin. The pattern distortion correction device comprises a finished pattern anticipation section anticipating a finished pattern of a layout pattern, an edge shift value measure section measuring an edge shift value which is a gap between an anticipated finished pattern and a standard pattern, a process margin measure section measuring a process margin of the anticipated finished pattern, a measure result determination section determining whether or not a measured edge shift value and a measured process margin satisfy a determination standard, and a layout pattern temporary correction section correcting the layout pattern so as to satisfy the determination standard based on a determination result by the measure result determination section.

### BACKGROUND OF THE INVENTION

1. Field of the Invention

The present invention relates to a pattern distortion correction technique by which pattern distortion generated in a pattern formation process, such as optical lithography or etching employed in a semiconductor fabrication, is anticipated and a portion in which the pattern distortion is generated is detected and corrected by examining the difference between the anticipation and a design layout pattern.

2. Description of the Related Art

To date, the design rule of a semiconductor device has reached to 0.15 μm level, and it is the present state that the design rule is smaller than a light-source wavelength (0.248 μm in the case in which KrF excimer laser is employed) of a lens scale-down projection aligner (stepper) for transferring the design rule. Since the resolution extremely deteriorates in this state, the resolution is tried to be improved by means of a special transfer technique, such as a distortion lighting technique.

When this special transfer technique is employed, although the resolution improves, the fidelity of a pattern remarkably deteriorates. In other processes, such as an etching process, a dimension fluctuation of a pattern occurs due to the difference in coarse/fine patterns since patterns have become minute.

In order to deal with these problems, OPC (optical proximity effect correction) process is widely employed. In the OPC process, a design layout pattern is distorted so as to obtain a desired pattern. Here, the OPC process means not only to merely be an optical process but also to be the process which corrects a pattern distortion in general caused by a process.

There are three types of OPC process methods. One of them is model base OPC process in which a pattern is distorted based on the result of a simulation. Another is rule base OPC process in which a way for distorting a design layout pattern (OPC process rule) is set in advance considering graphical characteristics of the design layout pattern, that is, a width of each pattern, a distance from an adjacent pattern, a distance from a corner portion, and the like, and based on this rule, a design layout pattern is distorted. The last one is hybrid OPC process in which a combination of the aforementioned two OPC process methods is employed.

In the OPC processes except the rule base OPC process described above, it is necessary to perform a simulation while a design layout pattern or a pattern corresponding to that which is obtained after an OPC process is taken as an input. The present invention relates to the model base OPC process and the hybrid OPC process.

FIG. 15 is an explanatory view for explaining the structure of a pattern distortion correction device of a prior art. This pattern distortion correction device comprises a before-correction layout pattern hold section 11, a layout pattern information input section 12, a layout pattern correction repeat section 13, an after-correction layout pattern information output section 14, an after-correction layout pattern hold section 15, an anticipation method hold section 20, and a determination standard hold section 21.

The before-correction layout pattern hold section 11 stores a layout pattern to be inputted. The layout pattern information input section 12 reads the information of the before-correction layout pattern hold section 11 and inputs it to the layout pattern correction repeat section 13. The layout pattern correction repeat section 13 performs correction for the layout pattern inputted. The after-correction layout pattern information output section 14 outputs after-correction layout information produced in the layout pattern correction repeat section 13. The after-correction layout pattern hold section 15 stores the information that the after-correction layout pattern information output section 14 outputs. The anticipation method hold section 20 stores an anticipation method of a finished pattern. The determination standard hold section 21 stores a determination standard regarding the finished pattern.

The layout pattern correction repeat section 13 comprises thereinside a finished pattern anticipation section 16-n (n=1, . . . , N), a finished pattern edge shift value measure section 17, an edge shift value measure result determination section 18, and a layout pattern temporary correction section 19. The finished pattern anticipation section 16-n (n=1, . . . , N) performs a simulation for a layout pattern in accordance with a specified anticipation method stored in the anticipation method hold section 20. The finished pattern edge shift value measure section 17 measures an edge shift value which means a difference between a standard layout pattern and the finished pattern anticipated at the finished pattern anticipation section 16-n (n=1, . . . , N).

Here, the standard pattern corresponds to a pattern representing a shape which is anticipated to be finished on a wafer. Typically, the standard pattern is the same as a before-correction layout pattern though there is a case in which a pattern which is obtained by given a graphic process, such as sizing, to the before-correction layout pattern, may be employed as the standard pattern.

The edge shift value measure result determination section 18 reads the determination standard from the determination standard hold section 21 and determines whether or not the finished pattern satisfies the determination standard. When the finished pattern satisfies the determination standard, the correction is completed, and when it does not, the layout pattern temporary correction section 19 distorts the pattern, for example, by shifting a pattern edge. A temporary correction for a pattern is repeated by the finished pattern anticipation section 16-n (n=1, . . . , N), the finished pattern edge shift value measure section 17, the edge shift value measure result determination section 18, and the layout pattern temporary correction section 19 until the pattern satisfies the determination standard.

Next, operations are explained.

FIG. 16 shows a flowchart of the pattern distortion correction of the prior art. First, the layout pattern read from the before-correction layout pattern hold section 11 is inputted (step S51). Then, with respect to the inputted layout pattern, the simulation of the finished pattern is performed in accordance with the anticipation method stored in the anticipation method hold section 20 (FIG. 15) (step S52). A distortion value (the edge shift value) between the standard pattern and the finished pattern is then measured based on a finished anticipation result obtained in the simulation of step S52 (step S53). Respective A, B, C, and D in FIG. 9 show concrete examples of edge shift values.

The determination of the edge shift value obtained at step S53 is performed in accordance with the determination standard stored in the determination standard hold section 21 (FIG. 15) (step S54). When the edge shift value satisfies the determination standard, correction is completed, and operation proceeds to step S56, and when it does not, operation proceeds to step S55. At step S55, the layout pattern is temporarily corrected, and operation returns to step S52. Typically, it is often treated as the determination standard that the number of repeats of step S52 to step S55 exceeds a predetermined number, or the pattern distortion value becomes a specific value or smaller. At step S55, the pattern is temporarily corrected so as to eliminate the edge shift value obtained at step S53. The most typical method is that in which the pattern edge is moved only the amount of the pattern distortion in the opposite direction to the direction in which the pattern distortion occurs.

Here, step S55 is made for the temporary correction since typically the finished pattern does not correspond to the standard pattern merely by moving the pattern edge only the amount of the pattern distortion in the opposite direction to the direction in which the pattern distortion occurs. Thus, in order to improve the correction accuracy, it is necessary to repeatedly perform the temporary correction, the simulation, the measure, and the determination while the correction amount is changed little by little. A method may be employed wherein after the pattern edge is moved only a predetermined amount for only first one time, a process is performed as described above so as to repeatedly perform the correction. When the correction for the layout pattern is completed, a correction layout pattern is outputted and is stored in the after-correction layout pattern hold section 15 at step S56.

By performing the operations described above, conventionally, the OPC process using a simulation (model base OPC process) has been performed. In fact, an entire layout pattern is appropriately divided while a hierarchical structure and the like is considered so that the edge of the pattern existing in the regions which are obtained by the dividing is divided for each said region, and a correction (movement of the edge) is performed for each said divided edge. At this time, the OPC process employing a simulation is realized by determining whether or not the pattern for each region or in a peripheral portion of the edge is correctly corrected. As described above, by employing the conventional method, the OPC process can be performed so that the shape of the finished pattern on a wafer which is anticipated on the simulation is made close to the standard pattern.

As other concrete examples in which OPC processes are performed so as to make the finished pattern close to the standard pattern, Japanese Patent Application Laid-Open No. 11-102062 and Japanese Patent Application Laid-Open No. 11-218899 are disclosed. In the mask data correction device and the mask data correction method disclosed in Japanese Patent Application Laid-Open No. 11-102062, a process conversion difference generated through a series of processes is measured, and a desired design pattern is obtained by correcting design data while the measured process conversion difference or the value calculated based on this process conversion difference is regarded as a correction value for correcting a corresponding pattern among design patterns. Here, the process conversion difference corresponds to an edge shift value that is the difference between the finished pattern and the standard pattern which occurs in each process of transferring, developing, and etching under the same process condition.

In the correction method and its device for a mask pattern disclosed in Japanese Patent Application Laid-Open No. 11-218899, a mask pattern is produced through a design pattern, and a simulation of a transfer image obtained in the case in which exposure is performed employing the mask pattern is performed so as to correct the mask pattern based on the difference between the transfer image simulated and the design pattern so that a desired design pattern is obtained.

However, there are problems in the conventional methods as the below.

The problems will be concretely explained employing FIG. 1.

FIG. 1(a) shows an OPC before-process layout pattern 1 and a finished pattern 2 anticipated by the OPC before-process layout pattern 1. FIG. 1(a) shows that the finished pattern 2 is thin relative to the layout pattern 1, and particularly line end portions of the pattern 2 taper off largely.

FIG. 1(b) is a view for explaining a final correction result obtained in a prior art. FIG. 1(b) shows the OPC before-process layout pattern 1, an OPC after-process layout pattern 3, and a finished pattern 4 obtained as the result of performing a simulation, taking the OPC after-process layout pattern 3 as an input. Here, the OPC before-process layout pattern 1 is regarded as the standard pattern 1. As the result of performing an OPC process for the OPC before-process layout pattern 1, as shown in FIG. 1(b), the pattern 1 becomes the OPC after-process layout pattern 3 in which the edge is shifted in both line portions and the line end portions. The simulation result of the OPC after-process layout pattern 3 of FIG. 1(b) becomes the finished pattern 4 so as to obtain an aiming pattern by the OPC process.

However, in a semiconductor process, process conditions change subtly due to factors, such as fluctuations in a device, a material, other environments, bumps on the surface of a wafer, and the like. Influences on a finished pattern due to the fluctuations in the process conditions can be anticipated by a simulation through changes of parameters, such as an exposure value, a defocus value, and the like.

FIG. 1(c) shows a finished pattern 5 obtained through fluctuations in process conditions. In this finished pattern 5, a bridge is generated in the central portion. The OPC before-process layout pattern 1 and the OPC after-process layout pattern 3 in FIG. 1(c) correspond to the OPC before-process layout pattern 1 and the OPC after-process layout pattern 3 in FIG. 1(b), respectively. In this example, since hammer-heads in the line ends are added too much in order to make the line ends of the finished pattern of in FIG. 1(b) close to the standard pattern 1, both the line ends draw near, and the bridge is generated as shown in FIG. 1(c) when the process conditions fluctuate.

In this way, in a state where process conditions are optimum, even when the finished pattern 2 which is close to the standard pattern 1 as shown in FIG. 1(b) is obtained, there is a case in which an improper pattern of bridge occurs as shown in FIG. 1(c) if process conditions fluctuate. This problem occurs since any prior arts have not considered that process conditions fluctuate. That is, in prior arts, there is a problem that a process margin cannot be considered when an OPC process is performed. Here, the “process margin” in the present description corresponds to conditions of a finished pattern which have significant meaning in circuit operations considering the influence on a pattern due to a fluctuation in process conditions.

### SUMMARY OF THE INVENTION

The present invention is developed to solve the aforementioned problems so as to provide a pattern distortion correction device, a pattern distortion correction method, and a recording medium recording a pattern distortion correction program wherein the process margin can be considered by measuring the process margin and performing an OPC process, regarding the result of the measure of the process margin as a determination standard.

In order to solve the above described problem, a pattern distortion correction device according to the first aspect of the present invention comprising a finished pattern anticipation section anticipating a finished pattern of a layout pattern, an edge shift value measure section measuring an edge shift value which is a gap between an anticipated finished pattern and a standard pattern, a measure result determination section determining whether or not a measured edge shift value satisfies a determination standard, and a layout pattern temporary correction section correcting the layout pattern so as to satisfy the determination standard based on a determination result by the measure result determination section, the correction device being characterized in comprising a process margin measure section measuring a process margin, the measure result determination section determining whether not only the measured edge shift value but also a measured process margin satisfy the determination standard or not.

With the pattern distortion correction device according to the first aspect of the present invention, an OPC process result in which the process margin is considered can be obtained.

The pattern distortion correction device according to the second aspect of the present invention is characterized in that in the pattern distortion correction device according to the first aspect, the process margin is an edge shift value under a condition in which a process condition is fluctuated.

With the pattern distortion correction device according to the second aspect of the present invention, an OPC process result in which the edge shift value is considered under a condition in which a process condition is fluctuated can be obtained.

The pattern distortion correction device according to the third aspect of the present invention is characterized in that in the pattern distortion correction device according to the first aspect, the process margin is the ratio of the change value of the edge shift value to the change value of the process condition.

With the pattern distortion correction device according to the third aspect of the present invention, an OPC process result in which the process margin is secured can be obtained.

The pattern distortion correction device according to the fourth aspect of the present invention is characterized in that in the pattern distortion correction device according to the first aspect, the process margin is a graphical characteristic of a finished pattern of a corrected layout pattern and a pattern or finished pattern of another mask.

With the pattern distortion correction device according to the fourth aspect of the present invention, an OPC process result in which the process margin with another mask is considered can be obtained. Further, with this pattern distortion correction device, the correction of a layout pattern can be speeded up by employing another mask as it is.

The pattern distortion correction device according to the fifth aspect of the present invention is characterized in that in the pattern distortion correction device according to the fourth aspect, the graphical characteristic is an area of an overlap or a between-edge distance in the finished pattern of the corrected layout pattern and the finished pattern of another mask.

With the pattern distortion correction device according to the fifth aspect of the present invention, an OPC process result in which the process margin with another mask is considered can be obtained. Further, with this pattern distortion correction device, the correction of a layout pattern can be speeded up by employing another mask as it is.

The pattern distortion correction device according to the sixth aspect of the present invention is characterized in that in the pattern distortion correction device according to the first aspect, the process margin is an optical intensity under a condition in which a process condition is fluctuated.

With the pattern distortion correction device according to the sixth aspect of the present invention, an OPC process result in which the edge shift value of a finished pattern is minimized can be obtained while the occurrence of an HT dimple is restrained.

A pattern distortion correction device according to the seventh aspect of the present invention is characterized in that the correction device comprises a finished pattern anticipation section anticipating a finished pattern of a layout pattern, a process margin measure section measuring a process margin which is a difference between the width of an anticipated finished pattern and the width of the standard pattern, a measure result determination section determining whether or not a measured process margin satisfies a determination standard, and a layout pattern temporary correction section correcting the layout pattern so as to satisfy the determination standard based on a determination result by the measure result determination section.

With the pattern distortion correction device according to the seventh aspect of the present invention, an OPC process result in which the width of the finished pattern is close to the width of the standard pattern can be obtained.

The pattern distortion correction device according to the eighth aspect of the present invention is characterized in that in the pattern distortion correction device according to the first aspect, the measure result determination section employs the result of a device simulation and a circuit simulation employing a finished pattern anticipated by the finished pattern anticipation section.

With the pattern distortion correction device according to the eighth aspect of the present invention, an OPC process result which satisfies the standard of a device and circuit and in which the finished pattern is close to the standard pattern can be obtained.

The pattern distortion correction device according to the ninth aspect of the present invention is characterized in that in the pattern distortion correction device according to the first aspect, the determination standard is that the value of a function taking a measure result value as an input is a minimum or a maximum.

With the pattern distortion correction device according to the ninth aspect of the present invention, all measure results are determined comprehensively so that an optimum OPC process result can be obtained.

The pattern distortion correction device according to the tenth aspect of the present invention, in the pattern distortion correction device according to the first aspect, comprises an anticipation process optimization section optimizing the order of anticipation by the finished pattern anticipation section, measure by the edge shift value measure section, measure by the process margin measure section, and determination by the measure result determination section based on a determination condition.

With the pattern distortion correction device according to the tenth aspect of the present invention, the number of processing steps can be reduced, and correction processing of a layout pattern can be speeded up, by optimizing the order of anticipation, measure, and determination based on the determination condition.

The pattern distortion correction device according to the eleventh aspect of the present invention is characterized in that in the pattern distortion correction device according to the tenth aspect, the determination condition comprises a conditional branch and/or a logical operation of the determination result.

With the pattern distortion correction device according to the eleventh aspect of the present invention, the number of processing steps can be reduced, and correction processing of a layout pattern can be speeded up, by optimizing the order of anticipation, measure, and determination based on the determination condition comprising the conditional branch and/or the logical operation of the determination result.

The pattern distortion correction device according to the twelfth aspect of the present invention is characterized in that in the pattern distortion correction device according to the first aspect, the device parallel performs anticipation by a plurality of finished pattern anticipation section and further parallel performs the measure by the edge shift value measure section and the measure by the process margin measure section.

With the pattern distortion correction device according to the twelfth aspect of the present invention, correction processing of a layout pattern can be speeded up since plural processes are performed by parallel processing.

The pattern distortion correction device according to the thirteenth aspect of the present invention, in the pattern distortion correction device according to the first aspect, comprises a verification flag output section outputting the result of the measure result determination section as a flag.

With the pattern distortion correction device according to the thirteenth aspect of the present invention, a portion where correction has not been correctly performed can be detected by the detection flag.

The pattern distortion correction device according to the fourteenth aspect of the present invention is characterized in that in the pattern distortion correction device according to the first aspect, the process margin is a graphical characteristic of the layout pattern or the corrected layout pattern and a layout pattern adjacent thereto.

With the pattern distortion correction device according to the fourteenth aspect of the present invention, the resource employed at execution time can be reduced and processing can be speeding up by employing graphical processing for the anticipation by simulation with a heavy processing load. Further, with this pattern distortion correction device, an OPC process result in which a finished pattern is close to a standard pattern can be obtained in preventing process margin deterioration, as in the case in which a bridge occurs when process fluctuation occurs.

The pattern distortion correction device according to the fifteenth aspect of the present invention is characterized in that in the pattern distortion correction device according to the fourteenth aspect, the graphical characteristic is a distance between edges.

With the pattern distortion correction device according to the fifteenth aspect of the present invention, the resource employed at execution time can be reduced and processing can be speeding up by employing graphical processing for the anticipation by simulation with a heavy processing load. Further, with this pattern distortion correction device, an OPC process result in which a finished pattern is close to a standard pattern can be obtained in preventing process margin deterioration, as in the case in which a bridge occurs when process fluctuation occurs.

A pattern distortion correction method according to the sixteenth aspect of the present invention comprising the steps of anticipating a finished pattern of a layout pattern, measuring an edge shift value which is a gap between an anticipated finished pattern and a standard pattern, determining whether or not a measured edge shift value satisfies a determination standard, and correcting the layout pattern so as to satisfy the determination standard based on a determination result by the determining step, the correction method being characterized in comprising the step of measuring a process margin, the determining step determining whether not only the measured edge shift value but also a measured process margin satisfy the determination standard or not.

With the pattern distortion correction method according to the sixteenth aspect of the present invention, an OPC process result in which the process margin is considered can be obtained.

The pattern distortion correction method according to the seventeenth aspect of the present invention is characterized in that in the pattern distortion correction device according to the sixteenth aspect, the method repeatedly performs at least one step among the anticipating step, the step of measuring the edge shift value, the determining step, the correcting step, and the step of measuring the process margin.

With the pattern distortion correction method according to the seventeenth aspect of the present invention, a high accuracy OPC process result in which the process margin is considered can be obtained by repeatedly performing anticipation, measure, determination, and correction of a pattern.

A computer readable recording medium according to the eighteenth aspect of the present invention, the computer readable recording medium recording a program to be performed by a computer, the program being for a pattern distortion correction and comprising the processes of anticipating a finished pattern of a layout pattern, measuring an edge shift value which is a gap between an anticipated finished pattern and a standard pattern, determining whether or not a measured edge shift value satisfies a determination standard, and correcting the layout pattern so as to satisfy the determination standard based on a determination result by the determining process, the recording medium is characterized in that the program comprises the process of measuring a process margin, the determining process determining whether not only the measured edge shift value but also a measured process margin satisfy the determination standard or not.

With the recording medium according to the eighteenth aspect of the present invention, an OPC process result in which the process margin is considered can be obtained by a computer performing the pattern distortion correction program recorded in the recording medium.

The computer readable recording medium according to the nineteenth aspect of the present invention is the computer readable recording medium according to the eighteenth aspect recording the pattern distortion correction program. This pattern distortion correction program is a program for letting a computer repeatedly perform at least one process among the anticipating process, the process of measuring the edge shift value, the determining process, the correcting process, and the process of measuring the process margin.

With the recording medium according to the nineteenth aspect of the present invention, a high accuracy OPC process result in which the process margin is considered can be obtained by a computer performing the pattern distortion correction program recorded in the recording medium.

### BRIEF DESCRIPTION OF THE DRAWINGS

FIG. 1 is explanatory views for explaining OPC before-process layout patterns and OPC after-process layout patterns.

FIG. 2 is an explanatory view for explaining the structure of a pattern distortion correction device.

FIG. 3 is a flowchart of a pattern distortion correction.

FIG. 4 is a flowchart of a layout pattern correction.

FIG. 5 is a flowchart of a layout pattern correction.

FIG. 6 is explanatory views of the third embodiment.

FIG. 7 is explanatory views of the fourth embodiment.

FIG. 8 is explanatory views of the fifth embodiment.

FIG. 9 is explanatory views of the sixth embodiment.

FIG. 10 is an explanatory view for explaining the structure of a pattern distortion correction device of the ninth embodiment.

FIG. 11 is a flowchart of a layout pattern correction.

FIG. 12 is a flowchart of a layout pattern correction.

FIG. 13 is an explanatory view for explaining the structure of a pattern distortion correction device of the twelfth embodiment.

FIG. 14 is a flowchart of a layout pattern correction.

FIG. 15 is an explanatory view for explaining the structure of a pattern distortion correction device of a prior art.

FIG. 16 is a flowchart of a pattern distortion correction of the prior art.

### DETAILED DESCRIPTION OF THE PREFERRED EMBODIMENTS

### Embodiment 1

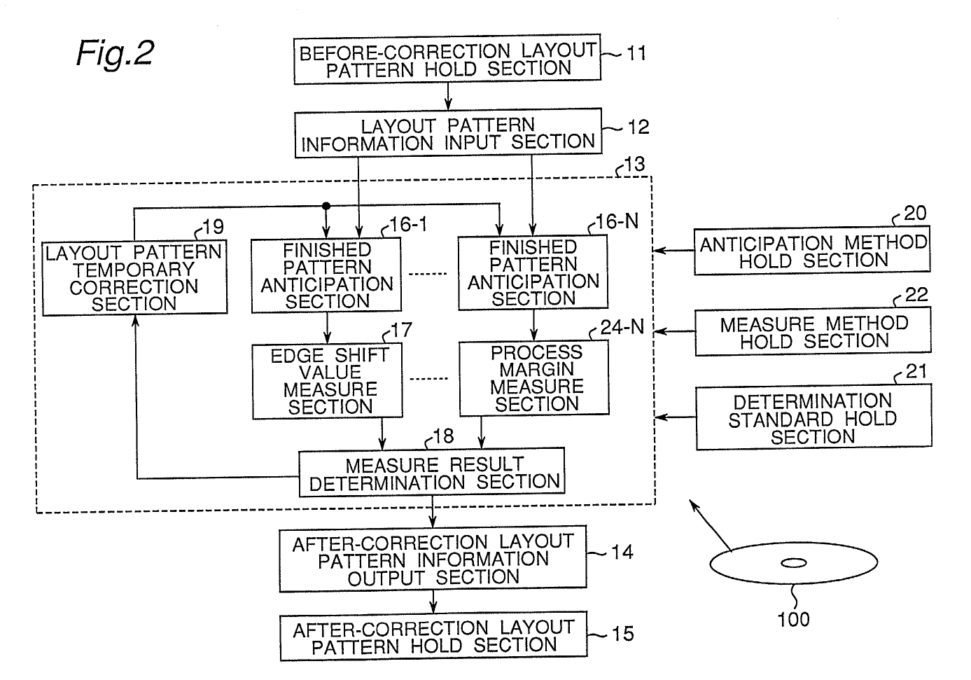

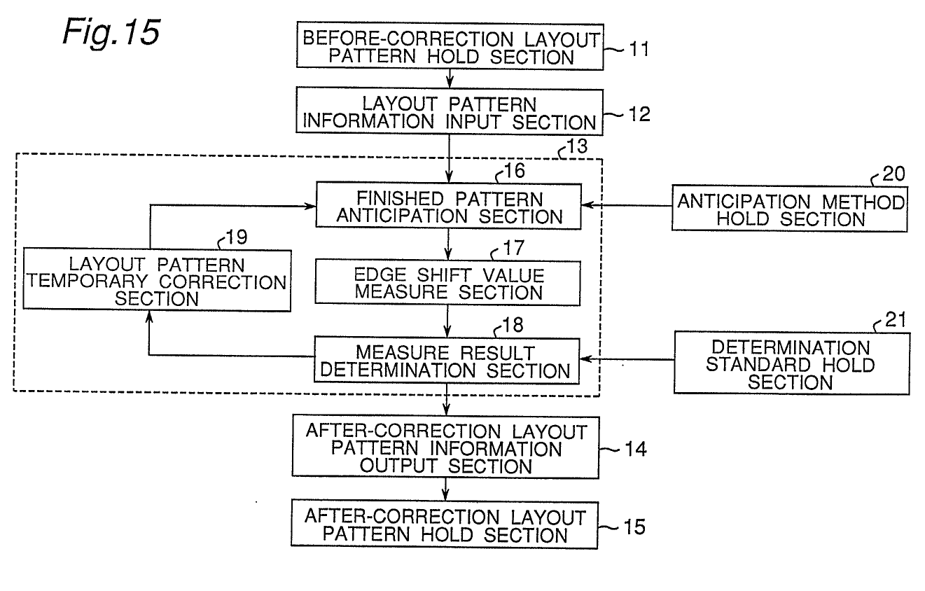

FIG. 2 is an explanatory view for explaining the structure of a pattern distortion correction device of Embodiment 1. The before-correction layout pattern hold section 11, the layout pattern information input section 12, the after-correction layout pattern information output section 14, and the after-correction layout pattern hold section 15 are the same as those in FIG. 15. The present structure differs from the conventional one in that the layout pattern correction repeat section 13 comprises a process margin measure section 24-n (n=2, . . . , N), and two or more of the finished pattern anticipation section 16-n (n=1, . . . , N). Accompanied with this, a measure method hold section 22 and a measure result determination section 8 receiving the output of the edge shift value measure section 17 and the process margin measure section 24-n (n=2, . . . , N) are added to the layout pattern correction repeat section 13.

Here, the finished pattern anticipation section 16-n (n=1, . . . , N) may be two or three or more. The number of the process margin measure section 24-n (n=2, . . . , N) is one less than that of the finished pattern anticipation section 16-n (n=1, . . . , N). The anticipation method hold section 20 stores a plurality of anticipation methods employed in the finished pattern anticipation section 16-n (n=1, . . . , N). The determination standard hold section 21 stores the determination standard employed in the measure result determination section 18. The measure method hold section 22 stores the measure methods employed in the edge shift value measure section 17 and the process margin measure section 24-n (n=2, . . . , N). The anticipation method hold section 20 and the measure method hold section 22 may be one each or be divided into plural sections as far as they hold plural anticipation methods or measure methods.

In FIG. 2, the anticipation method hold section 20, the determination standard hold section 21, and the measure method hold section 22 are depicted as if they are connected to the layout pattern correction repeat section 13. In fact, the anticipation method hold section 20 is connected to the respective finished pattern anticipation sections 16-n (n=1, . . . , N), the determination standard hold section 21 is connected to the measure result determination section 18, and the measure method hold section 22 is connected to the edge shift value measure section 17 and the respective process margin measure sections 24-n (n=2, . . . , N). Next, operations of the pattern distortion correction device of FIG. 2 will be explained. In the beginning, the operation to correct a layout pattern, concerning a process margin, which is a characteristic of the present invention, will be explained, and the operation to correct a layout pattern of Embodiment 1 will be explained later on.

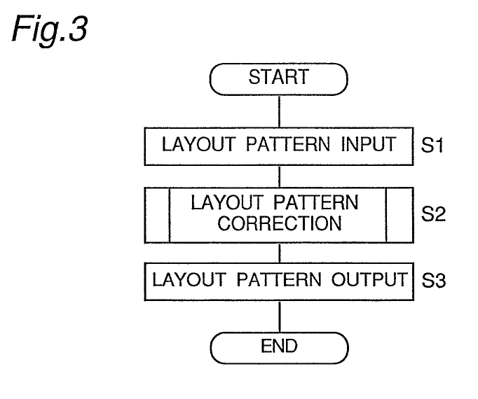

FIG. 3 is a flowchart of a pattern distortion correction. First, the layout pattern information input section 12 reads the pattern stored in the before-correction layout pattern hold section 11 and inputs it in the layout pattern correction repeat section 13 (step S1). Then, the layout pattern correction repeat section 13 corrects the layout pattern (step S2). This correction for the layout pattern will be explained later on. The after-correction layout pattern information output section 14 outputs a corrected pattern generated in the layout pattern correction repeat section 13 to the after-correction layout pattern hold section 15, and the after-correction layout pattern hold section 15 stores the correction layout pattern (step S3).

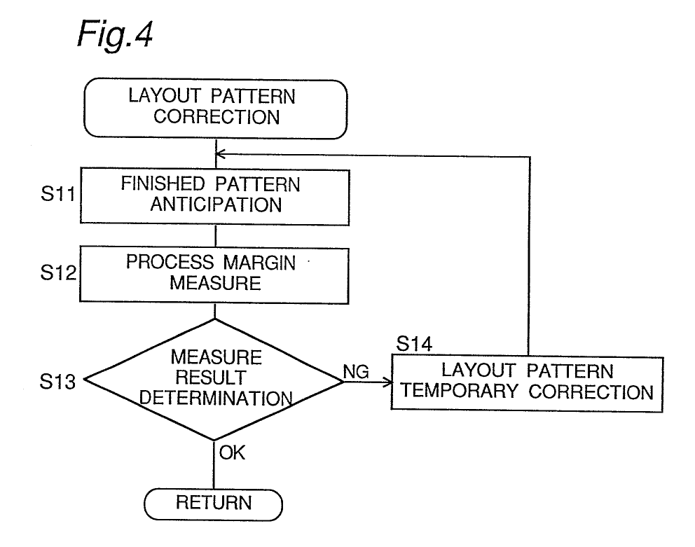

FIG. 4 is a flowchart of a layout pattern correction (step S2 of FIG. 3). Here, the present layout pattern correction differs from the conventional one in that there are step S11 in which a finished pattern is anticipated in accordance with the anticipation methods stored in the anticipation method hold section 20 and step S22 in which a process margin is measured in accordance with the measure methods stored in the measure method hold section 22.

At step S11, first, the finished pattern anticipation section 16-n (n=1, . . . , N) reads the anticipation methods stored in the anticipation method hold section 20 and anticipates a finished pattern a under condition in which a process condition is fluctuated in accordance with the anticipation methods. At step S12, the process margin measure section 24-n (n=2, . . . , N) reads the measure methods stored in the measure method hold section 22 and measures the process margin of the finished pattern anticipated at step S11 in accordance with the measure methods.

At step S13, the measure result determination section 18 reads the determination standard stored in the determination standard hold section 21 and determines whether or not the process margin measured at step S12 satisfies the determination standard. When the measured process margin satisfies the determination standard, the correction is completed, and operation returns to step S2 of FIG. 3, and if not, operation proceeds to step S14. At step S14, the layout pattern temporary correction section 19 performs a temporary correction for the layout pattern, and operation returns to step S11 . An OPC process result considering the process margin can be obtained by performing the temporary correction by changing the layout pattern little by little and repeating step S11 to step S14 until the determination standard is satisfied.

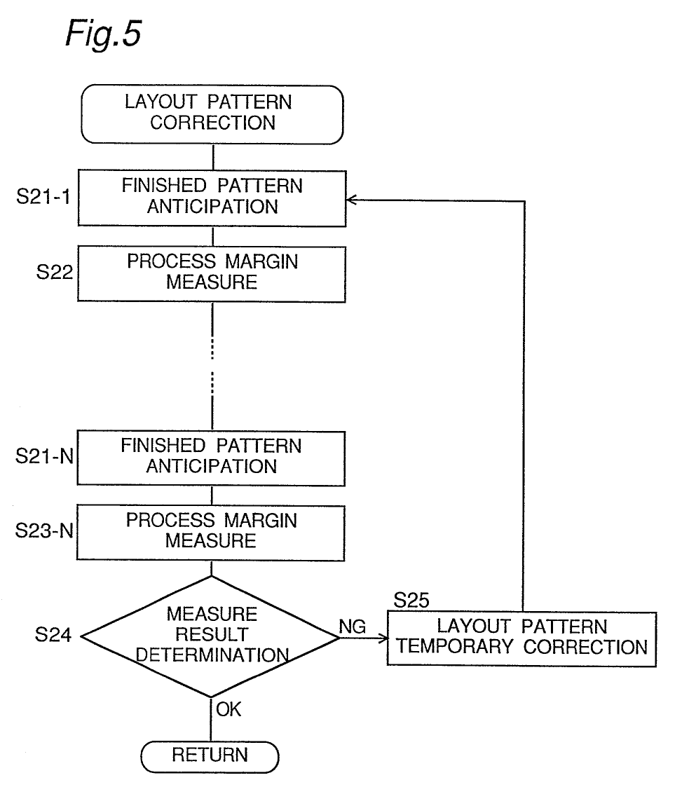

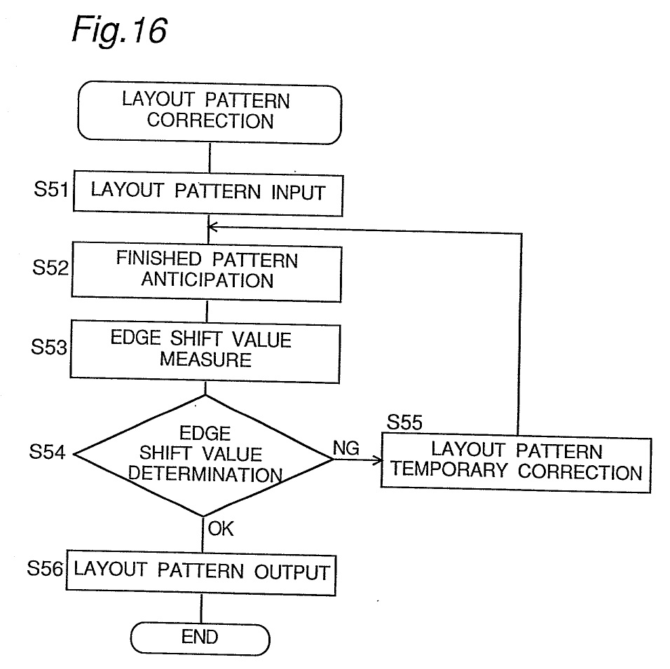

FIG. 5 shows a flowchart of the layout pattern correction (step S2 of FIG. 3). Steps S21-1, S22 in FIG. 5 are the same as steps S51, S52 in FIG. 16. Steps S21-n (n=2, . . . , N), s23-n (n=2, . . . , N) in FIG. 5 are the same as steps S11, S12 in FIG. 4. FIG. 5 differs from FIG. 4 in that steps S21-1, S22 are added to FIG. 5. Since steps S21-1 to step S23-N are the same as any ones of steps in FIG. 4 or FIG. 16 as described above, their explanation is omitted. The measure result of the process margin and the edge shift value of the finished pattern can be obtained by performing step S21-1 to step S23-N.

Then, at step S24, the measure result determination section 18 reads the determination standard stored in the determination standard hold section 21 and performs the determination with respect to the measure result of the process margin and the edge shift value of the finished pattern in accordance with the determination standard. When the plural determination results satisfy the determination standard, the correction is completed, and if not, operation proceeds to step S25. At step S25, the layout pattern temporary correction section 19 performs temporary correction for the layout pattern so as to satisfy the determination standard by the method that is the same as the conventional and returns to step S21-1. The OPC process result considering the edge shift value and the process margin can be obtained by repeating step S21-1 to step S25 until the determination standard is satisfied.

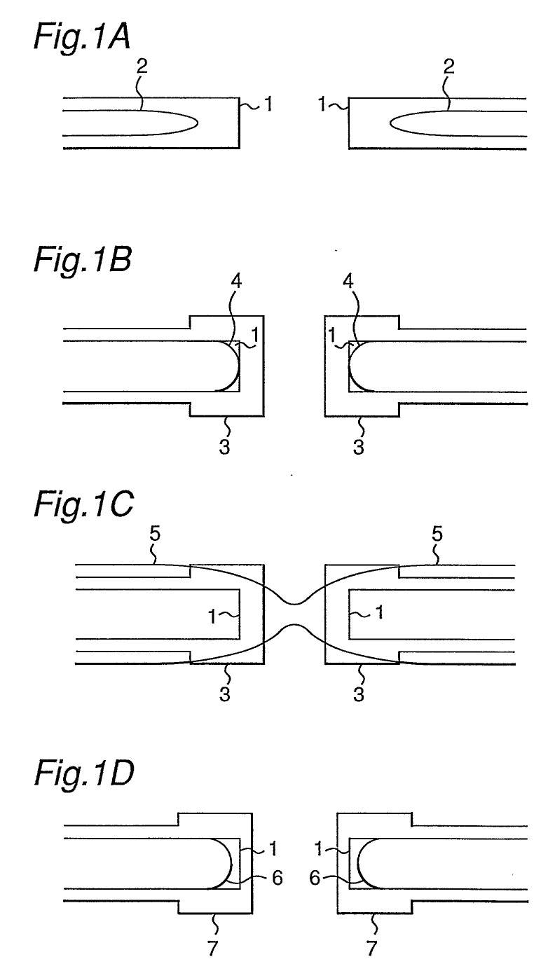

Next, a result obtained in Embodiment 1 will be explained referring to FIG. 1.

FIG. 1(d) is a view showing an OPC process result considering the edge shift value and the process margin FIG. 1(d) shows the standard pattern 1, an OPC after-process layout pattern 7, and a finished pattern 6 of the OPC after-process layout pattern 7. In comparing the finished pattern 6 of FIG. 1(d) with the finished pattern 2 of FIG. 1(b), although the line end portions of the finished pattern 6 rather retreat compared with the finished pattern 2, a bridge as shown in FIG. 1(c) can be avoided even when a process condition is fluctuated. By employing the present embodiment, an OPC process result considering both edge shift value and process margin can be obtained as shown in FIG. 1(d).

A combination of the measure of the edge shift value and the measure of one or plural process margins which may be expected to be typically used is described here. However, even when the measure of the edge shift value is not performed (that is, when steps S21-1, S22 of FIG. 5 are not included), the OPC process result considering the process margin can be obtained. Further, it is obvious that as far as an anticipation step goes ahead of a measure step corresponding to the anticipation step, even when the process order from step S21-1 to step S23-N of FIG. 5 are changed, similar effect can be obtained.

### Embodiment 2

The block diagram of a pattern distortion correction device and the flowchart of a pattern distortion correction of Embodiment 2 are similar to those of Embodiment 1.

Embodiment 2 is the one in which particularly, the anticipation methods, the determination standard, and the measure methods stored in the anticipation method hold section 20, the determination standard hold section 21, and the measure method hold section 22 of FIG. 2 in Embodiment 1 are set as follows.

Anticipation method 1: A finished pattern is anticipated by a method similar to the conventional one (without considering a process fluctuation).

Measure method 1: An edge shift value of the finished pattern is measured.

Anticipation method 2: A finished pattern is anticipated under the condition in which a process condition is fluctuated.

Measure method 2: An edge shift value of the finished pattern is measured.

Determination standard: The edge shift value obtained by Measure method 1 is within a specified value and a minimum under the condition in which the edge shift value obtained by Measure method 2 is within the specified value.

Conditional branch employing logical operations is needed in order to perform determination for the result with respect to plural measure methods as shown in the determination standard. In the present embodiment, this conditional branch is that “the edge shift value obtained by Measure method 2≦the specified value” and “the edge shift value obtained by Measure method 1≦the specified value” and “the edge shift value obtained by Measure method 1 is a minimum.” The layout pattern temporary correction section 19 performs the correction so as to satisfy the entire conditional branches at step S25 of FIG. 5. Further, repeating step S21-1 to step S25 plural times may be added to the determination standard. In this case, the layout pattern is corrected plural times, and an ideal one is chosen among these plural corrected patterns in the determination by the measure result determination section 18 (step S24).

It is possible to obtain an OPC process result in which a finished pattern close to a standard pattern is obtained as shown in FIG. 1(d) by repeating step S21-1 to step S25 under the conditions while process margin deterioration, such as the occurrence of a bridge, is prevented at the time of process fluctuation.

### Embodiment 3

The block diagram of a pattern distortion correction device and the flowchart of a pattern distortion correction of Embodiment 3 are similar to those of Embodiment 1.

Embodiment 3 is the one in which particularly, the anticipation methods, the determination standard, and the measure methods stored in the anticipation method hold section 20, the determination standard hold section 21, and the measure method hold section 22 of FIG. 2 in Embodiment 1 are set as follows.

Anticipation method 1: A finished pattern is anticipated by a method similar to the conventional one (without considering a process fluctuation).

Measure method 1: An edge shift value of the finished pattern is measured.

Anticipation method 2: A finished pattern is anticipated under plural conditions in which a process condition (e.g., an exposure value, or a defocus value) is fluctuated.

Measure method 2: The ratio of the change value of the edge shift value to the change value of the process condition (e.g., an exposure value, or a defocus value) is measured as to the finished pattern anticipated under plural conditions.

Determination standard: The edge shift value obtained by Measure method 1 is within a specified value and a minimum under the condition in which the ratio of the change value of the edge shift value to the change value of the process condition obtained by Measure method 2 is within the specified value.

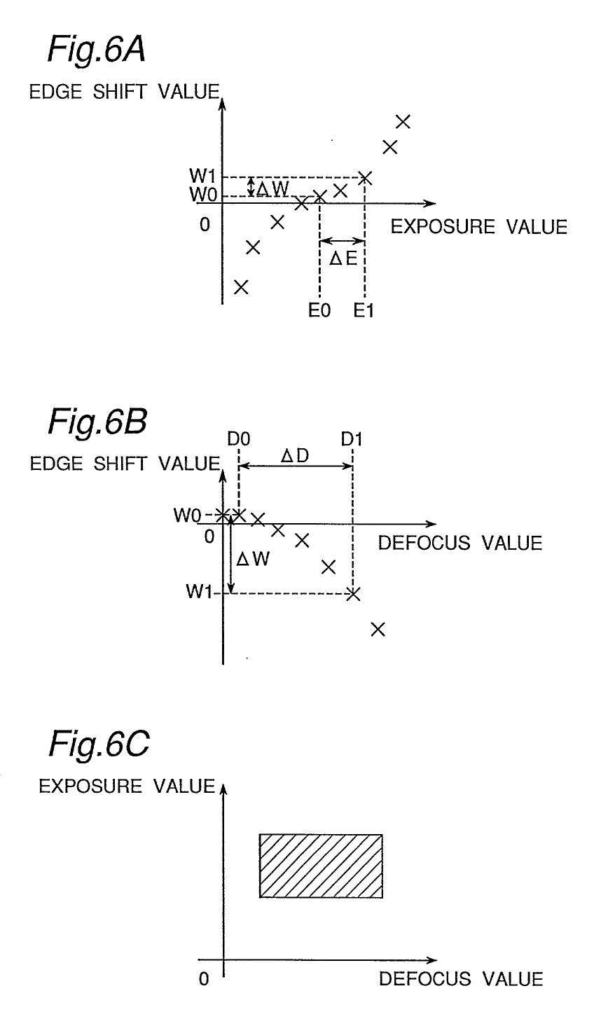

Below, the present embodiment will be explained employing the graph of FIG. 6.

FIG. 6(a) shows the edge shift value of a finished pattern with respect to the exposure value that is one of process conditions. The inclination differs if a layout pattern and its ambient condition differ even when process conditions other than the exposure value are the same. In an ideal state where there is no process fluctuation, the exposure value is E0, and at that time the edge shift value is W0. When the exposure value is fluctuated for some cause and becomes E1, the edge shift value is W1. That the absolute value |ΔW/ΔE| of the ratio of ΔW=W1−W0 to ΔE=E1−E0 is large means that the size of the finished pattern is largely fluctuated with respect to the fluctuation of the exposure value, that is, shows that the process margin is small.

FIG. 6(b) shows the edge shift value of a finished pattern with respect to a defocus value (a drift value from an ideal focal distance) that is one of process conditions The fluctuation of the defocus value occurs due to bumps or the like on a wafer. That the absolute value |ΔW/ΔD| of the ratio of a pattern edge shift value ΔW=W1−W0 to a defocus value fluctuation ΔD=D1−D0 is large means that the size of the finished pattern is largely fluctuated with respect to the fluctuation of the defocus value similarly to the example described above, that is, shows that the process margin is small.

As described above, simulations are performed under plural process conditions, and at each simulation the ratio of the change value of the edge shift value to the change value of the process condition can be regarded as the process margin, and thus these process margins have been widely employed. An OPC process in which the process margin is secured can be performed by performing the OPC process so that the process margin is smaller than the specified value or by repeating the temporary correction of the layout pattern so that the process margin becomes smaller.

Although an example in which the value of |ΔW/ΔE| or |ΔW/ΔD| is employed as it is explained here, the rate of the change value with respect to a design size value |ΔW/ΔE|/(design size value) or |ΔW/ΔD|/(design size value) may be treated as the process margin. By employing this process margin, an OPC process for a minute layout can be performed with higher accuracy than an OPC process for a thick pattern by which size accuracy does not need to be obtained. Further, as shown in FIG. 6(c), the exposure value is put to the vertical axis and the defocus value is put to the horizontal axis, and a region of (D, E) by which both |ΔW/ΔD| and |ΔW/ΔE| satisfy the specified value may be represented by a rectangle so that the area thereof may be employed as the process margin. A high accuracy OPC process can be performed also when this process margin is employed.

Further, repeating step S21-1 to step S25 of FIG. 5 plural times may be added to the determination standard. In this case, the layout pattern is corrected plural times, and an ideal corrected layout pattern is chosen among these plural corrected patterns in the determination by the measure result determination section 18 (step S24).

As described above, with the employment of the present embodiment, a high accuracy OPC process can be performed by securing the process margin while the edge shift value is minimized.

### Embodiment 4

The block diagram of a pattern distortion correction device and the flowchart of a pattern distortion correction of Embodiment 4 are similar to those of Embodiment 1.

Embodiment 4 is the one in which particularly, the anticipation methods, the determination standard, and the measure methods stored in the anticipation method hold section 20, the determination standard hold section 21, and the measure method hold section 22 of FIG. 2 in Embodiment 1 are set as follows.

Anticipation method 1: A finished pattern is anticipated by a method similar to the conventional one (without considering a process fluctuation).

Measure method 1: An edge shift value of the finished pattern is measured.

Anticipation method 2: A finished pattern is anticipated under the condition in which a process condition is fluctuated.

Measure method 2: An edge position of the finished pattern is measured.

Anticipation method 3: A finished pattern of a mask of another process is anticipated.

Measure method 3: After an edge position of the finished pattern is measured, the edge position obtained through Anticipation method 2 and the edge position obtained through Anticipation method 3 are compared, and an inclusive relationship of both processes is measured.

Determination standard: The edge shift value obtained by Measure method 1 is within a specified value and a minimum under the condition in which the edge position obtained by Anticipation method 3 is included in the edge position obtained by Anticipation method 2 in the result of Measure method 3.

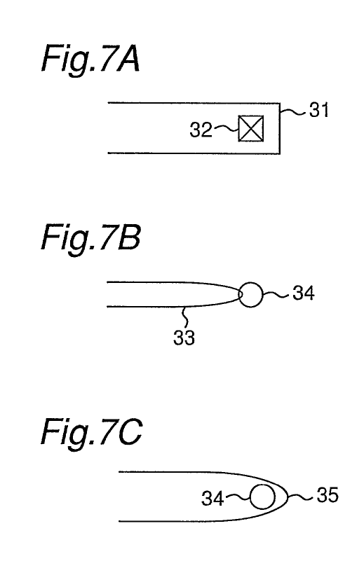

The present embodiment will be concretely explained, employing FIG. 7. FIG. 7(a) shows a design pattern 31 of wiring and a mask 32 of another process (here, a via connecting the wiring and wiring of another layer). FIG. 7(b) shows a finished pattern 33 of the wiring of FIG. 7(a) and a finished pattern 34 of the via of FIG. 7(a). The end portion of the wiring retreats largely and misses the via. Since the end portion of the wiring misses the via, it is not connected to the via, causing an operational problem of a circuit. FIG. 7(c) shows a finished pattern under an optimum process condition of the time when an OPC process is performed so that a standard pattern corresponds to a finished pattern as a conventional process. A finished pattern 35 of the wiring fully covers a finished pattern 34 of the via, avoiding an operational problem of a circuit.

However, when a process condition fluctuates, a finished pattern of a pattern to which a conventional OPC process is performed may become the one as the finished pattern 33 of FIG. 7(b). In this case, the end portion of the wiring retreats largely and misses the via. At this condition, since the via and the wiring are not connected, this case is similar to the case in which an OPC process is not performed on the standpoint of an operational problem of a circuit. When the method of the present embodiment is employed, since an OPC process is performed considering a finished pattern of the case in which there is a process fluctuation, it is possible to optimize an OPC process result so that the finished pattern 35 of the wiring of FIG. 7(c) includes the finished pattern 34 of the via.

The condition, “the finished pattern 35 of the wiring includes the finished pattern 34 of the via” can be specified as follows. These conditions are chosen in accordance with a process employed.

Condition 1: The finished pattern 34 of the via of FIG. 7(c) exists inside the finished pattern 35 of the wiring, and the distance between the edge of the via and the edge of the wiring is the specified value or greater.

Condition 2: An overlap area of the finished pattern 34 of the wiring of FIG. 7(c) and the finished pattern 35 of the via is a specified area or greater.

Condition 3: The overlap area of the finished pattern 34 of the wiring and the finished pattern 35 of the via of FIG. 7(c) is a specified rate of the area of the mask 32 of another process of FIG. 7(a) or greater.

Although the accuracy is reduced by employing the mask 32 of another process of FIG. 7(a) as it is, without employing a simulation in Anticipation method 3, the number of simulations can be reduced, thereby enabling a high speed.

Further, repeating step S21-1 to step S25 of FIG. 5 plural times may be added to the determination standard. In this case, the layout pattern is corrected plural times, and an ideal corrected layout pattern is chosen among these plural corrected layout patterns in the determination by the measure result determination section 18 (step S24).

With the employment of the present embodiment, it is possible to perform an OPC process highly accurately, considering the process margin with another mask (another process).

### Embodiment 5

The block diagram of a pattern distortion correction device and the flowchart of a pattern distortion correction of Embodiment 5 are similar to those of Embodiment 1.

Embodiment 5 is the one in which particularly, the anticipation methods, the determination standard, and the measure methods stored in the anticipation method hold section 20, the determination standard hold section 21, and the measure method hold section 22 of FIG. 2 in Embodiment 1 are set as follows.

Anticipation method 1: A finished pattern is anticipated by a method similar to the conventional one (without considering a process fluctuation)

Measure method 1: An edge shift value of the finished pattern is measured.

Anticipation method 2: A finished pattern is anticipated under the condition in which a process condition is fluctuated with respect to a place where there is a possibility that a dimple occurs (e.g., a central portion of four rectangles).

Measure method 2: A physical quantity (optical intensity in the present embodiment) of the finished pattern is measured.

Determination standard: A pattern is generated so that the physical quantity obtained by Measure method 2 becomes smaller than a specified value when the physical quantity is the specified value or greater, and further the edge shift value obtained by Measure method 1 is within the specified value and a minimum.

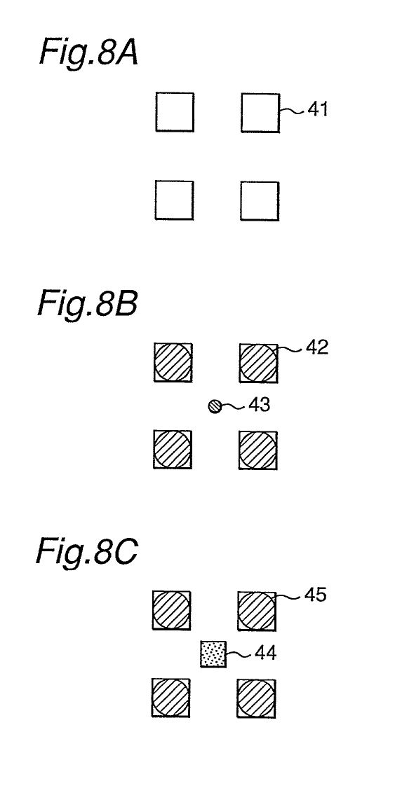

FIG. 8 will be explained. FIG. 8(a) shows a design layout pattern 41. In the present explanation, a standard pattern is treated as the same as the design layout pattern 41. The shaded portions of FIG. 8(b) show a finished pattern 42 of the design layout pattern 41. A finished pattern other than the layout pattern is generated in the central portion. This finished pattern which does not exist in the layout pattern is called a halftone dimple 43 (hereafter, referred to as an HT dimple).

The HT dimple 43 is often generated in a halftone type phase shift mask (HT mask) employed for improving resolution. However, it is normal that the HT dimple 43 is not detected under an optimum process condition and can be detected only by performing a simulation, considering a process fluctuation. Since this HT dimple 43 is an unnecessary pattern, a process for removing the HT dimple 43 is necessary. In Anticipation method 2, a place where there is a possibility that an HT dimple is generated is specified by a coordinate on a figure or a pattern obtained by graphic operations (sizing, between-layer operations AND/OR/NOT/XOR and the like).

FIG. 8(c) shows the result obtained by performing a correction for the HT dimple 43, employing the method of the present embodiment. The region shown by using dots corresponds to a pattern 44 generated by an OPC process, receiving the result of Measure method 2. Here, suppose that four parts of finished pattern 45 is designed so that light passes through on a photo mask. In that case, the pattern 44 is generated by adding a rectangle by which a small light passes on the central portion or by adding a rectangle by which light does not pass at all on the central portion. By producing this pattern 44, the generation of a central HT dimple can be restrained. Of course, when the HT dimple 43 does not occur, it is not necessary to generate the pattern 44.

Although the peripheral finished pattern 45 is influenced in the finishing through the generation of the pattern, when the layout temporary correction section 19 corrects the edge portion so as to minimize the edge shift value by Measure method 1, the edge shift value of the peripheral four parts of finished pattern 45 can be minimized.

Further, repeating step S21-1 to step S25 of FIG. 5 plural times may be added to the determination standard. In this case, the layout pattern is corrected plural times, and an ideal corrected layout pattern is chosen among these plural corrected layout patterns in the determination by the measure result determination section 18 (step S24).

With the employment of the present embodiment, it is possible to perform an OPC process by which the occurrence of the HT dimple 43 is restrained and the edge shift value of the peripheral finished pattern 45 is minimized.

### Embodiment 6

The block diagram of a pattern distortion correction device of Embodiment 6 corresponds to the one that the finished pattern anticipation section 16-1 and the edge shift value measure section 17 are removed from the block diagram of FIG. 2. The operations of the pattern distortion correction device are similar to those of Embodiment 1 except that step S21-1 and step S22 are unnecessary.

Embodiment 6 is the one in which particularly, the anticipation method, the determination standard, and the measure method stored in the anticipation method hold section 20, the determination standard hold section 21, and the measure method hold section 22 of FIG. 2 in Embodiment 1 are set as follows.

Anticipation method 1: A finished pattern is anticipated by a method similar to the conventional one (without considering a process fluctuation).

Measure method 1: The difference between the width of the finished pattern and the width of a standard pattern is measured.

Determination standard: The difference obtained by Measure method 1 is within a specified value.

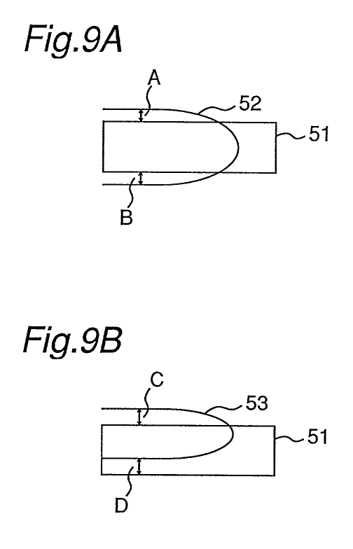

The present embodiment will be explained, referring to FIG. 9. FIG. 9(a), (b) show finished patterns of two corrected layout patterns. FIG. 9(a), (b) show a standard pattern 51, and finished patterns 52, 53 and further show edge shift values A, B, C, D. Here, the differences between the widths of the finished patterns and the width of the standard pattern are A+B, |C−D|, respectively. When A+B is the specified value or smaller, the finished pattern 52 is determined to satisfy the determination standard, and When |C−D| is the specified value or smaller, the finished pattern 53 is determined to satisfy the determination standard.

The determination standard may be that the number of correction repeating is a specified number or greater and the difference obtained by Measure method 1 is within a specified value and a minimum. In this case, since the correction of the layout pattern is repeated specified number of times, determination is performed regarding the specified number of corrected layout patterns. For example, the specified number may be two.

The below concerns the two finished patterns 52, 53 of corrected layout patterns. When A+B is a little smaller than C+D, the edge shift value of the finished pattern 53 is smaller than that of the finished pattern 52. Thus, in an aforementioned determination standard (minimizing the edge shift value), the finished pattern to be chosen as the final correction result has not been the finished pattern 53 (FIG. 9(b)) but the finished pattern 52 (FIG. 9(a)).

However, in OPC processes or the like for a gate pattern, what is important is not the edge shift value but the difference between the width of the finished pattern and the width of the standard pattern. In FIG. 9(a), the width of the finished pattern 52 is only A+B thicker than that of the standard pattern 51. In FIG. 9(b), the difference between the width of the finished pattern 53 and the width of the standard pattern 51 is |C−D|. Therefore, in accordance with the determination standard, the finished pattern 53 (FIG. 9(b)) in which the difference between the width of the finished pattern and the width of the standard pattern is small is chosen. When only a gate on an active region is taken out and the process is performed, the gate width which is important on a circuit operation can be highly accurately corrected. With the employment of the present embodiment, an OPC process in which not the edge shift value but the pattern width becomes close to the standard pattern can be performed.

### Embodiment 7

The block diagram of a pattern distortion correction device and the flowchart of a pattern distortion correction of Embodiment 7 are similar to those of Embodiment 1.

Embodiment 7 is the one in which particularly, the anticipation methods, the determination standard, and the measure methods stored in the anticipation method hold section 20, the determination standard hold section 21, and the measure method hold section 22 of FIG. 2 in Embodiment 1 are set as follows.

Anticipation method 1: A finished pattern is anticipated by a method similar to the conventional one (without considering a process fluctuation).

Measure method 1: An edge shift value of the finished pattern is measured.

Anticipation method 2: A finished pattern is anticipated under the condition in which a process condition is fluctuated (or without considering a process fluctuation) with respect to a specified place (e.g., a gate length of a transistor).

Measure method 2: A device simulation and a circuit simulation are executed, treating the finished pattern as an input.

Determination standard: The edge shift value obtained by Measure method 1 is within a specified value and a minimum in a range in which the standard for the device and the circuit is satisfied by Measure method 2.

The present embodiment will be explained, referring to FIG. 9. Here, FIG. 9(a) is an example in which a finished pattern becomes thicker than a standard pattern. FIG. 9(b) is an example in which a finished pattern becomes thinner than a standard pattern.

Suppose that the finished patterns 52, 53 are gates of transistors. As described in Embodiment 6, with respect to gates, it is preferred that the width of a finished pattern is close to the width of a standard pattern. This is because an operating speed of a transistor changes due to the width of a finished pattern. For example, since the width of the finished pattern 53 is close to the width of the standard pattern according to the determination standard, the operating speed of the transistor is within a design specified value, and since the width of the finished pattern 52 is not close to the width of the standard pattern, the operating speed of the transistor is outside of a design specified value. Thus, in this case, the layout temporary correction section 19 performs a correction regarding the width so that the finished pattern does not become thicker than the standard pattern and becomes close to the standard pattern.

Suppose that the finished patterns 52, 53 are wiring. The thicker the wiring becomes, the smaller the resistance becomes. The thinner the wiring becomes, the larger the resistance becomes. For example, since the finished pattern 52 of wiring is thicker than the standard pattern according to the determination standard, the resistance is small and is within a design specified value, and since the finished pattern 53 of wiring is thinner than the standard pattern, the resistance is large and is outside of a design specified value. Thus, in this case, the layout temporary correction section 19 performs a correction regarding the width so that the finished pattern does not become thinner than the standard pattern and becomes close to the standard pattern.

Further, repeating step S21-1 to step S25 of FIG. 5 plural times may be added to the determination standard. In this case, the layout pattern is corrected plural times, and an ideal corrected layout pattern is chosen among these plural corrected layout patterns in the determination by the measure result determination section 18 (step S24).

As described above, through the present embodiment, it is possible to perform an OPC process through which the standard on a device and a circuit is satisfied and the finished pattern is close to the standard pattern.

### Embodiment 8

The block diagram of a pattern distortion correction device and the flowchart of a pattern distortion correction of Embodiment 8 are similar to those of Embodiment 1.

Embodiment 8 is the one in which particularly, the determination standard stored in the measure method hold section 22 of FIG. 2 in Embodiment 1 are set as follows.

Determination standard: The value of a function f (Measure result 1, Measure result 2, . . . , Measure result N) is a minimum (or a maximum). As an example of the function, the following is given.

f(x1, x2, . . . , xN)=a1*x1+a2*x2+. . . +aN*xN

Here, xN represents Measure result N, and aN represents a weight coefficient regarding Measure result N (N=2, . . . , N).

In the foregoing embodiments, Measure results 1, 2, . . . , N can be employed for correction only when each satisfies all. Although which is to be given priority and which is to be ignored among measure results can be chosen by conditional branch, weighing some measure results has not been performed while all are considered. By determining whether or not the value of a function is a minimum (or a maximum), performing an optimum OPC process becomes possible while measure results are weighed and all measure results are considered comprehensively.

### Embodiment 9

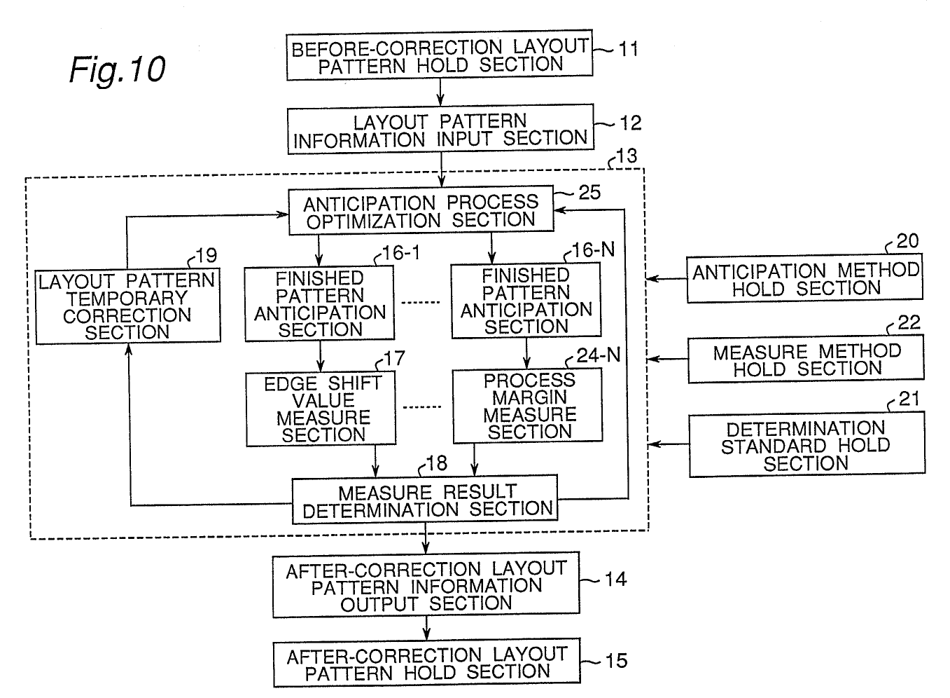

FIG. 10 is an explanatory view for explaining the structure of a pattern distortion correction device of Embodiment 9. FIG. 10 differs from FIG. 2 in that an anticipation process optimization section 25 is included. Since the present structure is the same as that of Embodiment 1 except the layout pattern correction repeat section 13, only the layout pattern correction repeat section 13 will be explained to avoid duplication.

The anticipation process optimization section 25 optimizes the order for performing anticipation, measure, and determination based on a determination condition. This determination condition is stored in the determination standard hold section 21. The anticipation process optimization section 25 outputs a layout pattern inputted from the layout pattern information input section 12 to the finished pattern anticipation section 16-i (i=1, . . . , N) which is the first to perform the anticipation. The finished pattern anticipation section 16-i anticipates a finished pattern based on an anticipation method stored in the anticipation method hold section 20.

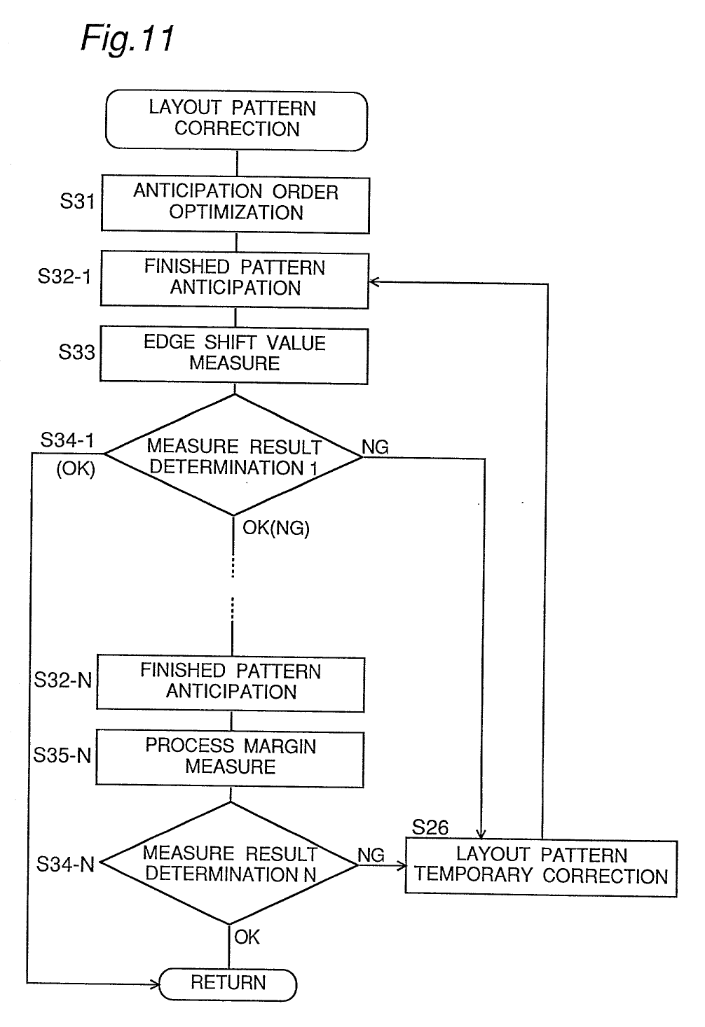

Then, when i=1, the edge shift value measure section 17 measures the edge shift value based on the measure method stored in the measure method hold section 22. When it is not i=1, the process margin measure section 24-i measures the process margin based on the measure method stored in the measure method hold section 22. The measure result determination section 18 then determines whether or not the measured edge shift value or the measured process margin satisfies the determination standard stored in the determination standard hold section 21. To which one of the after-correction layout pattern information output section 14, the layout pattern temporary correction section 19, and the anticipation process optimization section 25, the measure result determination section 18 outputs the layout pattern varies according to the determination condition. This corresponds to that there are three output results from step S34-1 of FIG. 11. The determination condition will be explained later on.

Then, the layout pattern temporary correction section 19 temporarily corrects the layout pattern outputted from the measure result determination section 18 based on the determination standard through the conventional method. The temporarily corrected layout pattern is outputted to the anticipation process optimization section 25. The anticipation process optimization section 25 outputs the inputted layout pattern or the temporarily corrected layout pattern to an optimum finished pattern anticipation section 16-j (j=1, . . . , N) based on the determination condition.

In FIG. 10, the anticipation method hold section 20, the determination standard hold section 21, and the measure method hold section 22 are depicted as if they are connected to the layout pattern correction repeat section 13. In fact, the anticipation method hold section 20 is connected to the respective finished pattern anticipation sections 16-n (n=1, . . . , N), the determination standard hold section 21 is connected to the measure result determination section 18 and the anticipation process optimization section 25, and the measure method hold section 22 is connected to the edge shift value measure section 17 and the respective process margin measure sections 24-n (n=2, . . . , N).

Operations will be explained, referring to FIG. 11. FIG. 11 shows a flowchart of a layout pattern correction (step 2 of FIG. 3). Comparing the flowchart of FIG. 11 with the flowchart of FIG. 5, step S32-n (n=1, . . . , N) and step S21-1, step S33 and step S22, step S35-n (n=2, . . . , N) and step S23-n (n=2, . . . , N), step S36 and step S25 are the same, respectively. FIG. 11 includes step S31, S34-1 to step S34-(N−1), which differs from FIG. 5. Although step S33 is for the edge shift value measure here, it may be for the process margin measure.

First, the anticipation process optimization section 25 reads the determination condition from the determination standard hold section 21, analyzes this determination condition, and optimizes the order of performing the anticipation, the measure, the determination (step S31). Then, step S32-1 and step S33 are performed so that the edge shift value that is the difference between the finished pattern and the standard pattern is measured. The measure result determination section 18 then reads the determination standard from the determination standard hold section 21 and determines whether or not the edge shift value measured at S33 satisfies this determination standard (step S34-1).

Next proceeding steps from step S34-1 change dependent upon the determination condition. This determination condition will be explained concretely. For example, the case in which N=2, and steps for the measure result determination are two of S34-1 and S34-2 will be explained. The determination condition is regarded as acceptance when the edge shift value measured at S33 satisfies the determination standard at step S34-1 and the process margin measured at S35-2 satisfies the determination standard at step S34-2. In this case, when the determination standard is not satisfied at step S34-1, regardless whether or not the determination standard is satisfied at step S34-2, it is decided that a temporary correction for the layout pattern has to be performed (corresponding to the NG which is not enclosed by parentheses).

When the determination standard is satisfied at step 34-1, the step proceeds to step S32-2 (corresponding to the OK which is not enclosed by parentheses). After that, since operations are the same as those in the flowchart of FIG. 5, the explanation thereof is omitted.

The determination condition is regarded as acceptance when the edge shift value measured at S33 satisfies the determination standard at step S34-1 or the process margin measured at S35-2 satisfies the determination standard at step S34-2. In this case, when the determination standard is satisfied at step S34-1, the step is completed and returns to step 2 of FIG. 3 (corresponding to the OK enclosed by parentheses).

When the determination standard is not satisfied at step S34-1, the step proceeds to step S32-2 (corresponding to the NG enclosed by parentheses). After that, since operations are the same as those in the flowchart of FIG. 5, the explanation thereof is omitted. Like this, the determinations for the measure results can be performed without performing both evaluations. When the number of steps of the determination for measured results is three or more, operations become a little bit complex. However, a technical idea that the order is optimized so as to reduce the number of process steps is the same.

Although the measure of the edge shift value goes ahead of the measure of the process margin here, the measure of the process margin may go ahead of the measure of the edge shift value, dependent upon a determination condition. With the present embodiment, when there is conditional branch in a determination condition, reducing the number of process steps, that is, speeding up processes, becomes possible by restraining the anticipation and the measure to a minimum.

### Embodiment 10

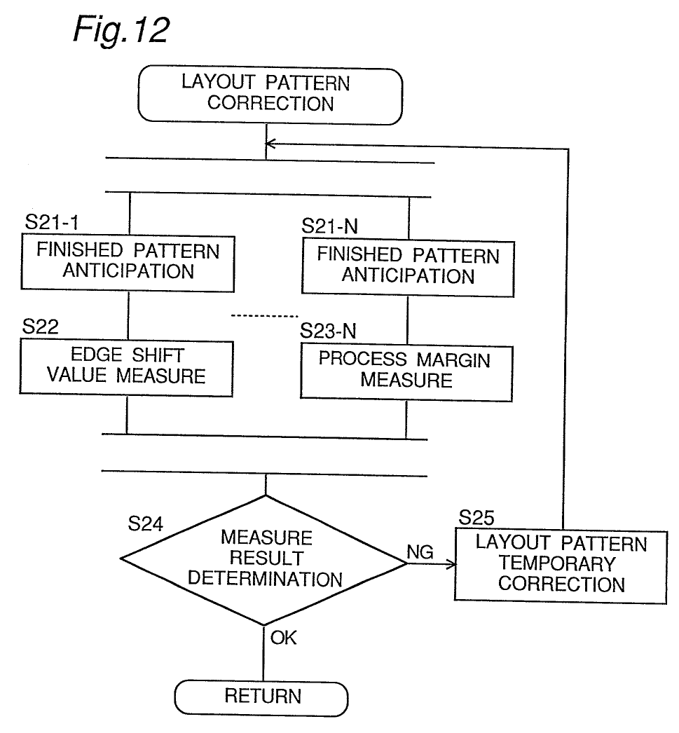

The block diagram of a pattern distortion correction device of Embodiment 10 is the same as that of FIG. 2. FIG. 12 is a flowchart of a layout pattern correction (step 2 of FIG. 3). The flowchart of FIG. 12 differs from the flowchart of FIG. 5 in that pairs of the finished pattern anticipation (step S21-1) and the edge shift value measure (step S22), and the finished pattern anticipation (step S21-n (n=2, . . . , N)) and the process margin measure (step S23-n (n=2, . . . , N)) are performed at the same time by parallel processing.

Repeating step S21 to step S25 of FIG. 12 plural times may be added to the determination standard. In this case, the layout pattern is corrected plural times, and an ideal corrected layout pattern is chosen among these plural corrected layout patterns in the determination by the measure result determination section 18 (step S24). Further, since the parallel processing is performed in the pattern distortion correction device by software, it is preferred that the same number of CPUs (not shown) as the number of pairs parallel processed are included.

With the present embodiment, the entire processing time can be shortened compared with Embodiment 1 in which processing is performed in turns one by one.

### Embodiment 11

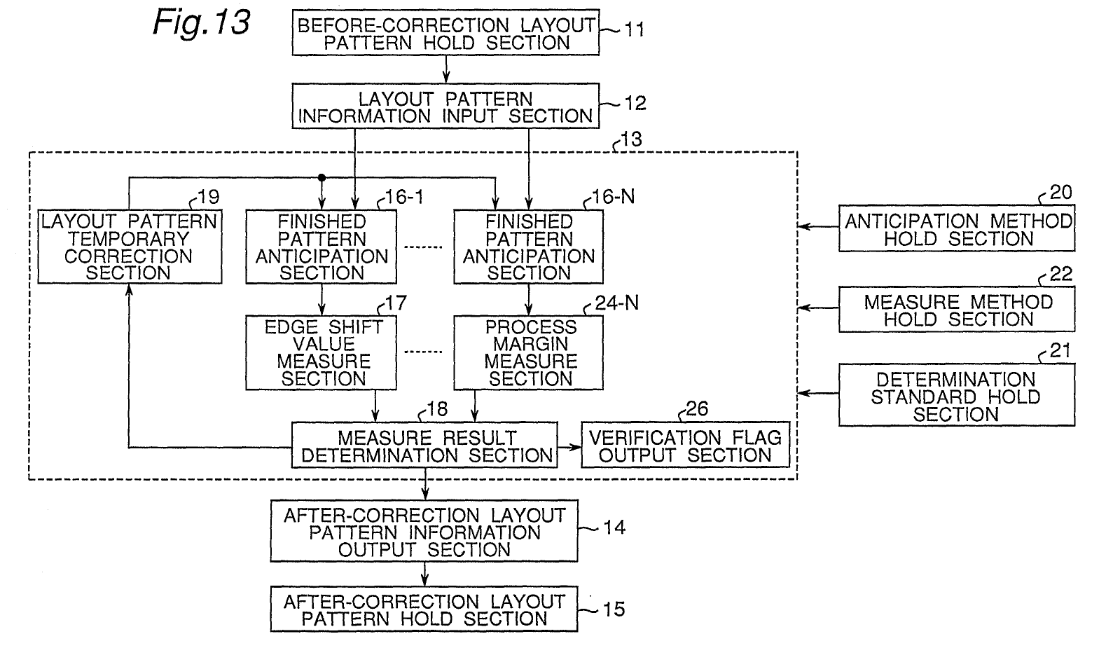

FIG. 13 is an explanatory view for explaining the structure of a pattern distortion correction device of Embodiment 11. FIG. 13 differs from FIG. 2 in that a verification flag output section 26 is included. The explanation for things which are the same as those in FIG. 2 will be omitted to avoid duplication. The verification flag output section 26 outputs a verification flag based on a signal that the measure result determination section 18 outputs.

In FIG. 13, the anticipation method hold section 20, the determination standard hold section 21, and the measure method hold section 22 are depicted as if they are connected to the layout pattern correction repeat section 13. In fact, the anticipation method hold section 20 is connected to the respective finished pattern anticipation sections 16-n (n=1, . . . , N), the determination standard hold section 21 is connected to the measure result determination section 18, and the measure method hold section 22 is connected to the edge shift value measure section 17 and the respective process margin measure sections 24-n (n=2, . . . , N).

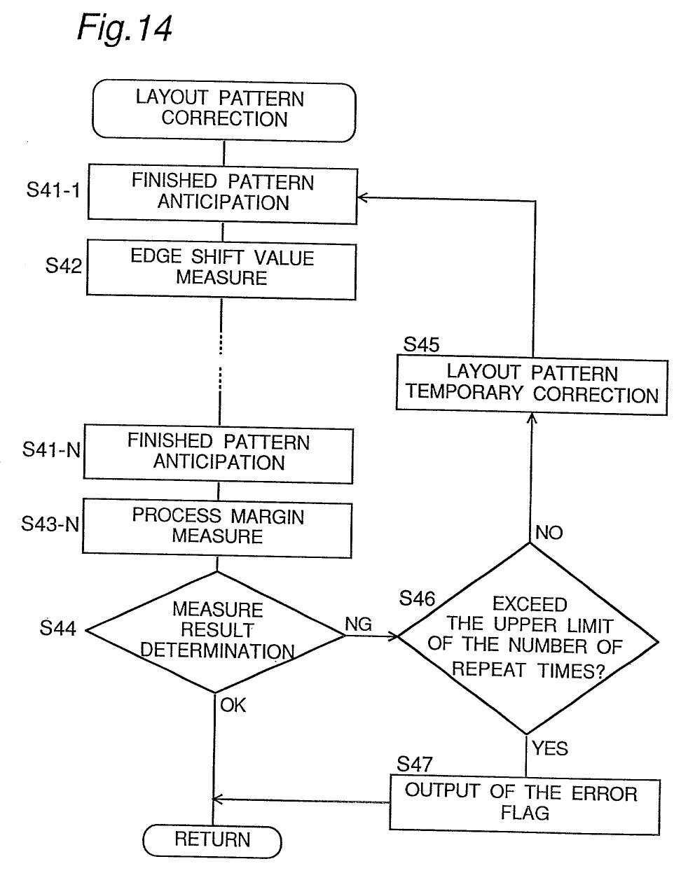

Next, operations will be explained. FIG. 14 shows a flowchart of a layout pattern correction (step 2 of FIG. 3). FIG. 14 differs from FIG. 5 in that step S47 is included. Although step S46 is also added for the convenience of explanation, since step S24 of FIG. 5 normally includes this condition, the difference is not essential. The explanation for the steps which are the same as those in FIG. 5 is omitted to avoid duplication.

When it is determined that the determination standard is not satisfied even after the specified number of temporary corrections are repeated at step S46, a verification flag is outputted at step S47. With this, the correction for the layout pattern is finished, and the step is returned to step 2 of FIG. 3. The portion in which the correction has not been correctly performed can be detected by means of the verification flag. A detailed OPC process, that is, an OPC process in which the anticipation method, the measure method, and the determination standard are further changed, can be performed for the portion on which the verification flag is generated. Further, when the number of repeating is one, the present pattern distortion correction device functions as a correction portion detection device by which the portion needing a correction can be detected by the verification flag.

If the pattern distortion correction device is employed as the correction portion detection device, in FIG. 14, it is not necessary to have the layout temporary correction section 19 as well as the way to return the layout pattern from the determination result determination section 18 to the finished pattern anticipation section 16-n (n=1, . . . , N).

### Embodiment 12

The block diagram of a pattern distortion correction device and the flowchart of a pattern distortion correction of Embodiment 12 are similar to those of Embodiment 1.

Embodiment 12 is the one in which particularly, the anticipation methods, the determination standard, and the measure methods stored in the anticipation method hold section 20, the determination standard hold section 21, and the measure method hold section 22 of FIG. 2 in Embodiment 1 are set as follows.

Anticipation method 1: A finished pattern is anticipated by a method similar to the conventional one (without considering a process fluctuation).

Measure method 1: An edge shift value of the finished pattern is measured.

Anticipation method 2: Anticipation is not performed.

Measure method 2: A graphical characteristic (distance between edges) between a layout pattern (or a temporarily corrected pattern) and a pattern adjacent thereto is measured.

Determination standard: The edge shift value obtained by Measure method 1 is within a specified value and a minimum under the condition in which the between-edge distance obtained by Measure method 2 is a specified value or greater.

The accuracy is deteriorated compared with the case in which a simulation is employed in Anticipation method 2 by setting in advance a graphical condition (here, the between-edge distance of the corrected pattern 3) through which the process margin is considerably reduced as shown in FIG. 1(c). However, the anticipation and measure of the process margin deterioration can be performed through graphical processing which is easy in computer processing. The accuracy can be improved a little bit by not indiscriminately specifying minimum values of the between-edge distance for all corrected patterns but by specifying minimum values of the between-edge distance for each width of corrected patterns in the determination standard.

Repeating step S21-1 to step S25 of FIG. 5 plural times may be added to the determination standard. In this case, the layout pattern is corrected plural times, and an ideal corrected layout pattern is chosen among these plural corrected layout patterns in the determination by the measure result determination section 18 (step S24).

With the present embodiment, since the anticipation through simulation with a heavy processing load is graphically processed, reducing the resource employed at execution time and speeding up processing become possible. Further, with the present embodiment, in preventing process margin deterioration, as in the case in which a bridge occurs when process fluctuation occurs, an OPC process result through which a finished pattern close to a standard pattern is obtained as shown in FIG. 1(d) can be obtained.

In the above, Embodiment 1 to Embodiment 12 are explained. These embodiments may be combined. In any embodiments, the respective structural sections constituting the pattern distortion correction device of FIG. 2, FIG. 10, or FIG. 13 may be performed by a CPU (not shown). The pattern distortion correction program operating the CPU is recorded in a recording medium, such as a CD-ROM 100 or a memory, such as a ROM (not shown) and is read from the recording medium or the memory when being performed. The recording medium may be a floppy disk or a DVD. Like this, a pattern distortion correction can be performed as software.

What is claimed is:

1. A pattern distortion correction device comprising:
a finished pattern anticipation section anticipating a finished pattern of a layout pattern;
an edge shift value measure section measuring an edge shift value which is a gap between an anticipated finished pattern and a standard pattern;
a measure result determination section determining whether or not a measured edge shift value satisfies a determination standard; and
a layout pattern temporary correction section correcting the layout pattern so as to satisfy the determination standard based on a determination result by the measure result determination section,
wherein the pattern distortion correction device comprises a process margin measure section measuring a process margin,
the measure result determination section determining whether not only the measured edge shift value but also a measured process margin satisfy the determination standard or not.

2. The pattern distortion correction device according to claim 1, wherein the process margin is an edge shift value under a condition in which a process condition is fluctuated.

3. The pattern distortion correction device according to claim 1, wherein the process margin is the ratio of the change value of the edge shift value to the change value of the process condition.

4. The pattern distortion correction device according to claim 1, wherein the process margin is a graphical characteristic of a finished pattern of a corrected layout pattern and a pattern or finished pattern of another mask.

5. The pattern distortion correction device according to claim 4, wherein the graphical characteristic is an area of an overlap or a between-edge distance in the finished pattern of the corrected layout pattern and the finished pattern of another mask.

6. The pattern distortion correction device according to claim 1, wherein the process margin is an optical intensity under a condition in which a process condition is fluctuated.

7. A pattern distortion correction device comprising:
a finished pattern anticipation section anticipating a finished pattern of a layout pattern;
a process margin measure section measuring a process margin which is a difference between the width of an anticipated finished pattern and the width of a standard pattern;
a measure result determination section determining whether or not a measured process margin satisfies a determination standard; and
a layout pattern temporary correction section correcting the layout pattern so as to satisfy the determination standard based on a determination result by the measure result determination section.

8. The pattern distortion correction device according to claim 1, wherein the measure result determination section employs the result of a device simulation and a circuit simulation employing a finished pattern anticipated by the finished pattern anticipation section.

9. The pattern distortion correction device according to claim 1, wherein the determination standard is that the value of a function taking a measure result value as an input is a minimum or a maximum.

10. The pattern distortion correction device according to claim 1 further comprising an anticipation process optimization section optimizing the order of anticipation by the finished pattern anticipation section, measure by the edge shift value measure section, measure by the process margin measure section, and determination by the measure result determination section based on a determination condition.

11. The pattern distortion correction device according to claim 10, wherein the determination condition comprises a conditional branch and/or a logical operation of the determination.

12. The pattern distortion correction device according to claim 1, wherein the device parallel performs anticipation by a plurality of finished pattern anticipation section and further parallel performs the measure by the edge shift value measure section and the measure by the process margin measure section.

13. The pattern distortion correction device according to claim 1 further comprising a verification flag output section outputting the result of the measure result determination section as a flag.

14. The pattern distortion correction device according to claim 1, wherein the process margin is a graphical characteristic of the layout pattern or the corrected layout pattern and a layout pattern adjacent thereto.

15. The pattern distortion correction device according to claim 14, wherein the graphical characteristic is a distance between edges.

16. A pattern distortion correction method comprising the steps of:
anticipating a finished pattern of a layout pattern;
measuring an edge shift value which is a gap between an anticipated finished pattern and a standard pattern;
determining whether or not a measured edge shift value satisfies a determination standard; and
correcting the layout pattern so as to satisfy the determination standard based on a determination result by the determining step,
wherein the method comprises the step of measuring a process margin,
the determining step determining whether not only the measured edge shift value but also a measured process margin satisfy the determination standard or not.

17. The pattern distortion correction method according to claim 16, wherein the method repeatedly performs at least one step among
the anticipating step,
the step of measuring the edge shift value,
the determining step,
the correcting step, and
the step of measuring the process margin.

18. A computer readable recording medium recording a program that is to be performed by a computer, the program being for a pattern distortion correction and comprising the processes of
anticipating a finished pattern of a layout pattern,
measuring an edge shift value which is a gap between an anticipated finished pattern and a standard pattern,
determining whether or not a measured edge shift value satisfies a determination standard, and
correcting the layout pattern so as to satisfy the determination standard based on a determination result by the determining process,
wherein the program comprises the process of measuring a process margin,
the determining process determining whether not only the measured edge shift value but also a measured process margin satisfy the determination standard or not.

19. The recording medium according to claim 18 recording a program by which at least one process is repeatedly performed by a computer among
the anticipating process,
the process of measuring the edge shift value,
the determining process,
the correcting process, and
the process of measuring the process margin.
